(19) United States
(12) Patent Application Publication
(10) Pub. No.: US 2022/0248870 A1
(43) Pub. Date: Aug. 11, 2022

(54) High-Security Mounting System for Retail Device Display

(71) Applicant: Google LLC, Mountain View, CA (US)

(72) Inventors: Christopher Graham Tewksbury, Fairfax, CA (US); Warit Tulyathorn, San Francisco, CA (US); Li Xu, San Francisco, CA (US); Ellen L. Ferguson, San Geronimo, CA (US); Darren Nicholas Kool, San Jose, CA (US)

(73) Assignee: Google LLC, Mountain View, CA (US)

(21) Appl. No.: 17/173,828

(22) Filed: Feb. 11, 2021

(51) Int. Cl. A47F 3/00; A47F 3/14; A47F 5/00

(52) U.S. Cl. CPC A47F 3/002; A47F 5/0043; A47F 3/14

(57) ABSTRACT

This document describes a high-security mounting system for retail device display. The mounting system includes a shelf and table system having a variety of security features that help reduce theft of electronic devices presented for retail display. The devices are mechanically fastened to a stand, which is mechanically fastened to a mounting surface of the mounting system using a series of holes defined in the mounting surface. A tray is fastened to an underside of the mounting surface and is usable to house the devices' electrical cords extending through the holes. A rigid placemat is attached to the stand and wraps around an edge of the mounting surface to capture a portion of the underside of the mounting surface to resist a pull force on the stand. Optionally, a riser can be used to adapt a device's configuration of mounting hardware to the holes in the mounting surface.

### BACKGROUND

Theft is a major concern for many retailers that present products for display, particularly expensive electronic devices. It can be useful for a person to be able to see, touch, and interact with a product prior to purchase. However, many electronic devices (e.g., smartphones, tablets, smart speakers) that have a small form factor and are on display for user interaction can be quickly stolen if adequate security measures are not in place.

### SUMMARY

This document describes a high-security mounting system for retail device display. The mounting system includes a security shelf and a security table, each having a variety of security features that help reduce theft of electronic devices presented for retail display on the mounting system. The devices are mechanically fastened to a stand, which is mechanically fastened to a mounting surface of the mounting system using a series of holes defined in the mounting surface. A tray is fastened to an underside of the mounting surface and is usable to hide the devices' electrical cords extending through the holes. A rigid placemat is attached to the stand and wraps around an edge of the mounting surface to capture a portion of the underside of the mounting surface to resist a pull force on the stand. Optionally, a riser can be used to adapt a device's configuration of mounting hardware to the holes in the mounting surface.

In aspects, a high-security mounting system for retail device display is disclosed. The mounting system includes a shelf, a tray, and one or more plugs. The shelf has a mounting surface on which to mechanically fasten one or more electronic devices for retail display. The shelf defines a series of holes distributed along a lengthwise direction of the shelf and is configured to receive threaded-stem fasteners corresponding to a device stand of the one or more electronic devices. The tray is attached to the shelf and positioned proximate to a bottom side of the shelf from the mounting surface to define a volume between the tray and the shelf that is usable to house electrical cords of the one or more electronic devices fastened to the mounting surface. The tray defines a series of slots aligned with the series of holes in the shelf and configured to receive the threaded-stem fasteners of the device stand. The threaded-stem fasteners are configured to mate with threaded-insert fasteners to secure the device stand to the shelf and the tray and provide a first degree of resistance against a pull force applied to the device stand. The plugs are configured to be inserted into one or more holes of the series of holes in the shelf that are not used for fastening the one or more electronic devices to the shelf Each plug is configured to extend through the volume to abut an interior surface of the tray that faces the bottom side of the shelf and connect to a threaded-stem fastener configured to capture an exterior surface of the tray that is opposite the interior surface to help retain the tray to the shelf.

In aspects, another high-security mounting system for retail device display is disclosed. The mounting system includes a tabletop, an electrical tray, and one or more plugs. The tabletop has a mounting surface on which to mechanically fasten one or more electronic devices for retail display. In addition, the tabletop defines a series of holes distributed along a lengthwise direction of the tabletop and configured to receive threaded-stem fasteners corresponding to a device stand of the one or more electronic devices to fasten the one or more electronic devices to the tabletop. The tabletop also defines a channel that runs in a lengthwise direction along a center axis of the tabletop and is configured to receive electrical cords of the one or more electronic devices fastened to the tabletop. The electrical tray is attached to the tabletop and positioned proximate to a bottom side of the tabletop to define a volume between the electrical tray and the tabletop that is usable to house the electrical cords of the one or more electronic devices fastened to the mounting surface. The plugs are configured to be removably inserted into one or more holes of the series of holes in the tabletop that are not used for mounting the one or more electronic devices. Each plug has a latch mechanism configured to retain the plug in a respective hole by capturing a bottom surface of the tabletop.

This summary is provided to introduce simplified concepts of a high-security mounting system for retail device display, which is further described below in the Detailed Description. This summary is not intended to identify essential features of the claimed subject matter, nor is it intended for use in determining the scope of the claimed subject matter.

### BRIEF DESCRIPTION OF THE DRAWINGS

The details of one or more aspects of a high-security mounting system for retail device display are described in this document with reference to the following drawings. The same numbers are used throughout the drawings to reference like features and components:

FIG. 1 illustrates an exploded view of an example high-security mounting system (e.g., security shelf) for retail device display;

FIG. 2 illustrates a top-right isometric view of the example security shelf from FIG. 1;

FIG. 3 illustrates a bottom-right isometric view of the example security shelf from FIG. 1;

FIG. 4 illustrates a sectional view of the example security shelf from FIG. 2, taken along line A-A;

FIG. 5A illustrates a top plan view of a placemat from FIG. 1;

FIG. 5B illustrates a bottom plan view of the placemat from FIG. 1;

FIG. 5C illustrates a right elevational view of the placemat from FIG. 1;

FIGS. 6A and 6B illustrate example implementations of the placemat assembled to the example security shelf from FIG. 1;

FIG. 7A illustrates a top-right isometric view of a riser from FIG. 1;

FIG. 7B illustrates a bottom-right isometric view of the riser from FIG. 1;

FIG. 8 illustrates a front-right isometric view of an example high-security mounting system (e.g., security table) for retail device display;

FIG. 9 illustrates an exploded view of the example security table from FIG. 8;

FIG. 10 illustrates a bottom-right isometric view of the example security table from FIG. 8;

FIG. 11 illustrates a right elevational view of the example security table from FIG. 8;

FIG. 12 illustrates a front elevational view of the example security table from FIG. 8;

FIG. 13 illustrates a top plan view of the example security table from FIG. 8; and

FIG. 14 illustrates a sectional view of the example security table from FIG. 13, taken along line B-B.

### DETAILED DESCRIPTION

This document describes a high-security mounting system for retail device display. The high-security mounting system provides a shelf or table for retail environments that addresses a high theft-rate of displayed electronic devices (e.g., smartphones, smart speakers, smart watches, tablets) in retail stores. The high-security mounting system enables devices to be mechanically fastened to the shelf or table in a way that is serviceable, reworkable, and increases the difficulty of theft of the devices. The mounting system provides multiple levels of resistance against a thief attempting to remove the device or a device stand from a mounting surface (e.g., a shelf, a table) on which the device or device stand is mounted.

While features and concepts of the described high-security mounting system for retail device display can be implemented in any number of different environments, aspects are described in the context of the following examples.

Example Device

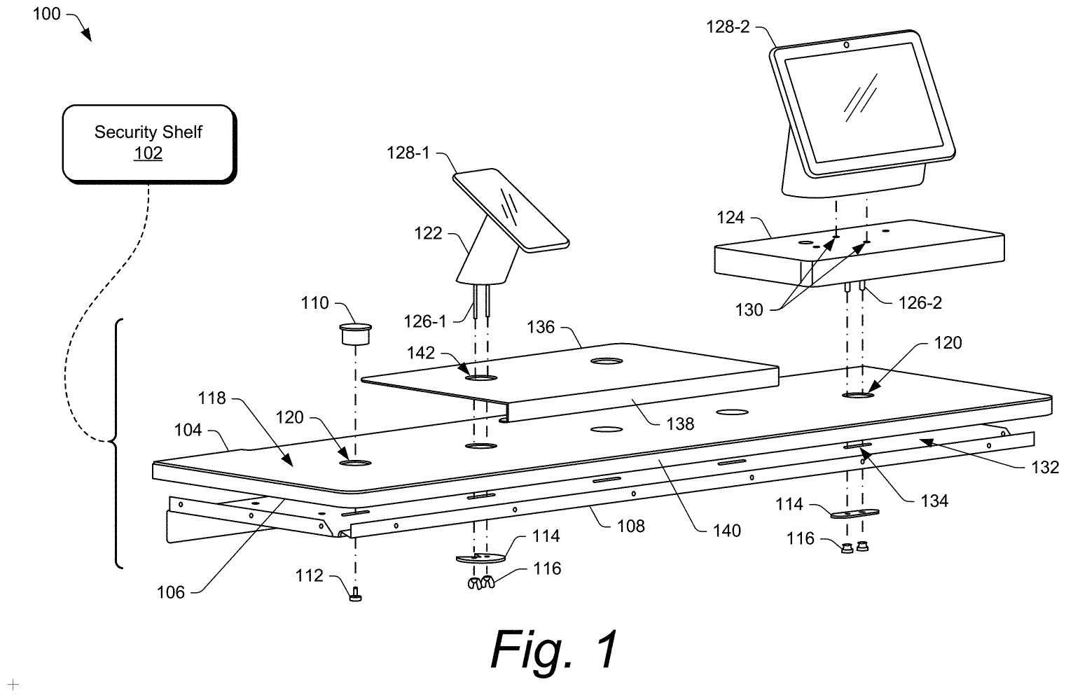

FIG. 1 illustrates an exploded view 100 of an example high-security mounting system (e.g., security shelf 102) for retail device display. The security shelf 102 includes a shelf 104, a trim 106, a tray 108, and a one or more plugs 110. The security shelf 102 also includes mechanical hardware, such as threaded-stem fasteners 112 (e.g., bolt, screw, stud), plates 114, and threaded-insert fasteners 116 (e.g., nut, wingnut, capnut, swage nut, knurled nut, butterfly nut).

The shelf 104 includes a mounting surface 118, which may be substantially planar. In addition, the shelf 104 may define a series of holes (e.g., holes 120) through which hardware from a stand (e.g., device stand 122, riser 124) may extend. For example, the device stand 122 may include threaded stems 126 (e.g., threaded stems 126-1) that can extend through the hole 120 in the mounting surface 118 to mate with threaded-insert fasteners 116 on the opposing side of the mounting surface 118 to retain the device stand 122 to the mounting surface 118. For retail display, an electronic device 128 (e.g., electronic device 128-1, electronic device 128-2) may be fastened to the device stand 122, which may be fastened to the mounting surface 118. In some aspects, if the electronic device 128 (e.g., electronic device 128-2) or the device stand 122 includes a configuration of mounting hardware that does not align with the hole(s) 120 in the mounting surface 118, then the electronic device 128 or the device stand 122 may be fastened to the riser 124 and the riser 124 fastened to the shelf 104. In this way, the riser 124 is configured as a mechanical-hardware adapter between the shelf 104 and the electronic device 128 or the device stand 122. For example, the riser 124 includes appropriate through-holes (e.g., holes 130) arranged to accommodate a mounting-hole pattern of the electronic device 128 to enable the electronic device 128 to be fastened to the riser 124. The riser 124 also includes threaded stems 126 (e.g., threaded stems 126-2) that are configured to extend through the hole 120 in the shelf 104 to mate with a threaded-insert fastener 116 on the opposing side of the shelf 104.

The tray 108 is positioned proximate to the underside of the shelf 104, which is opposite the mounting surface 118. The tray 108 includes a metal material and, when assembled to the shelf 104, creates a volume 132 between the tray 108 and the shelf 104 suitable to house and cords (e.g., power cords) connected to the electronic devices 128 that are mounted on the shelf 104. The threaded stems 126 of the device stand 122 or the riser 124 are extended through the holes (e.g., one or more of a series of slots 134) defined in the tray 108 and aligned with the holes 120 in the shelf 104. One or more plates 114 (e.g., a washer) having a hole may be positioned on the threaded stem 126 at a location between the threaded-insert fastener 116 and the tray 108 to distribute a load applied by the threaded-insert fastener 116 onto the tray 108. The tray 108 may have one or more holes corresponding to the threaded-stem fasteners 126. The threaded-insert fastener 116 may be attached to the threaded-stem fastener 126 and captured against the plate 114. The threaded-insert fastener 116 can be tightened onto the threaded stem 126 to tighten the plate 114 against the tray 108 and draw down the device stand 122 (or the riser 124) to the mounting surface 118. Accordingly, a compression force is provided between the plate 114 and the mounting surface 118 to secure the device stand 122 and the mounting surface 118 and secure the plate 114 to the tray 108. In this way, the mounting system includes a first degree of resistance against theft (e.g., a pulling force applied to the device stand 122 in an attempt to remove the device stand 122 from the mounting surface 118) of the electronic device 128, where the resistance is provided by the plate 114 being captured against the tray 108.

In some aspects, the security shelf 102 may also include a placemat 136, which may provide a second degree of resistance against theft. For example, the placemat 136 is a rigid material (e.g., metal material) that is positioned on the mounting surface 118 and includes an extending member 138 that wraps around an edge 140 of the shelf 104 (or around a portion of the trim 106) and captures a portion of the underside of the shelf 104 (or the trim 106). The placemat 136 also includes one or more holes 142 that correspond to one or more of the holes 120 in the shelf 104. In aspects, the device stand 122 may be attached to the placemat 136 via adhesive (e.g., Very High Bond (VHB) tape), which has a high bonding strength. In another example, the threaded stems 126 can be connected to additional mechanical fasteners (not shown in FIG. 1) on the underside of the placemat 136 to retain the placemat 136 to the device stand 122. Because the extending member 138 of the placemat 136 wraps around the edge of the shelf 104, the extending member 138 is captured against the underside of the shelf 104. Accordingly, when a person pulls upward on the device stand 122, the placemat 136 is captured against the underside of the shelf 104, providing resistance against the force of the pull.

When assembled, the threaded stems 126 of the device stand 122 extend through corresponding holes in the placemat 136, the mounting surface 118, the tray 108, and the plate 114. This assembly effectively provides two degrees of resistance against theft. The first degree of resistance includes the plate captured against the pan. The second degree of resistance includes the extending member 138 of the placemat 136 being captured against the underside of the shelf 104 (or the trim 106).

To avoid leaving the holes 120 in the shelf 104 open and the volume 132 accessible via the holes 120, the security shelf 102 may include one or more of the plugs 110, which can be inserted into corresponding holes (e.g., the holes 120) defined in the shelf 104. The threaded-stem fastener 112 can be inserted through the slot 134 defined in the tray 108 and fastened to the plug 110 via a threaded insert (not shown in FIG. 1) in the bottom of the plug 110 to retain the plug 110 in the hole 120. In addition to preventing access to the volume 132 via the holes 120, the plugs 110 also cosmetically fill the corresponding holes 120 that are not being used for mounting a device. Further details of this and other features are described below.

Each plug 110 includes a body having a diameter sufficient to be inserted into the corresponding hole 120 and a height sufficient to vertically traverse the volume 132 and abut the tray 108 underneath the shelf 104. The plug 110 also includes a head that has a larger diameter than the body and is coaxial with the body. These plugs are used to fill the corresponding hole when that hole is not being used for mounting a device to the mounting surface 118. The threaded-stem fasteners 112 may be inserted through the slot 134 and connected to the plug 110 to retain the plug 110 in the hole 120 and against the tray 108. A person with access to the underside of the mounting surface 118 may release the fastener to remove the plug from the hole.

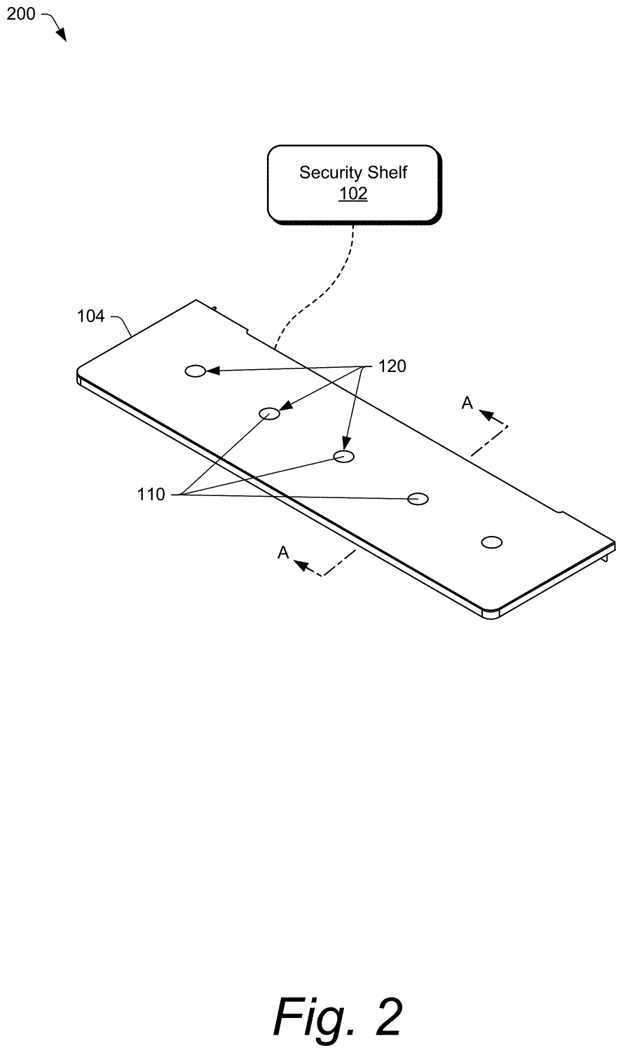

FIG. 2 illustrates a top-right isometric view 200 of an assembled version of the security shelf 102 from FIG. 1. In this example, the plugs 110 are positioned in the holes 120 in the shelf 104. Accordingly, no device or device mount is illustrated as being mounted to the shelf 104 in this example. As illustrated, the holes 120 are distributed along a lengthwise direction of the shelf 104 to provide multiple locations at which an electronic device may be attached for display. The distribution of the holes 120 also provides interchangeable locations for the placemat 136 to be positioned, due to the placemat 136 having a fixed distance between its hole(s) (e.g., holes 142) and the extending member 138 that wraps around the edge 140 of the shelf 104.

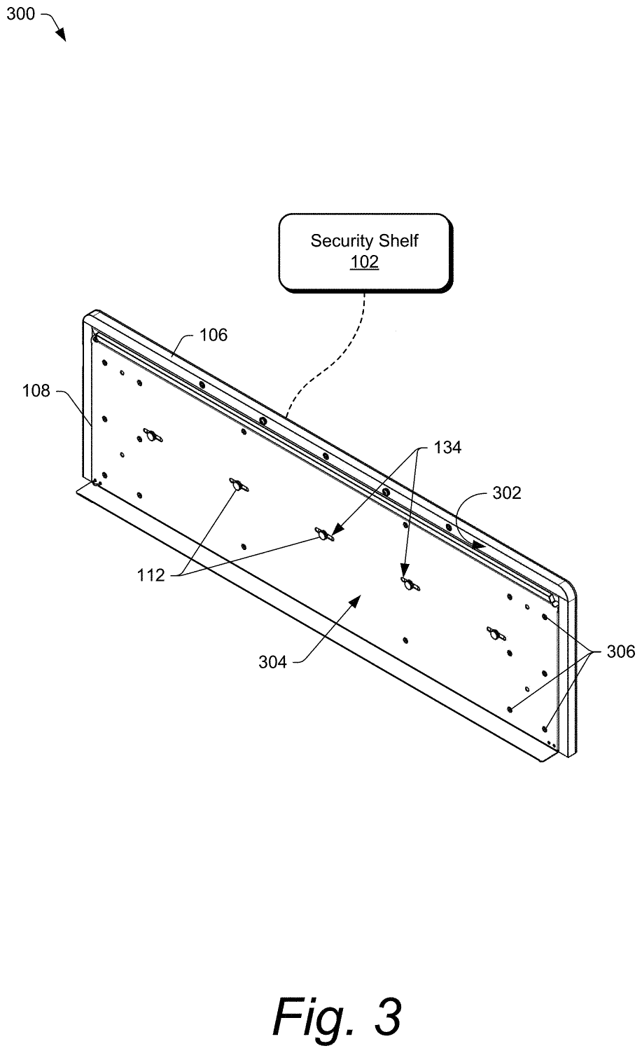

FIG. 3 illustrates a bottom-right isometric view 300 of the security shelf 102 from FIG. 2. In this example, the tray 108 is shown as being attached to the underside (e.g., underside 302) of the shelf 104 and framed by the trim 106. Further, the threaded-stem fasteners 112 are shown as being inserted through the slots 134 in the tray 108. Each of the threaded-stem fasteners 112 connect to one of the plugs 110 to retain the plug 110 in the hole 120 in the shelf 104, as shown in FIGS. 1 and 2. In this way, the threaded-stem fasteners 112 capture an exterior surface 304 of the tray 108 to help retain the tray 108 to the shelf 104. The tray 108 can also be attached to the shelf 104 by any number of suitable fasteners, including mechanical fasteners 306 (e.g., screws, bolts). The tray 108, when assembled to the shelf 104, effectively hides the volume 132 (shown in FIG. 1) and prevents access to it.

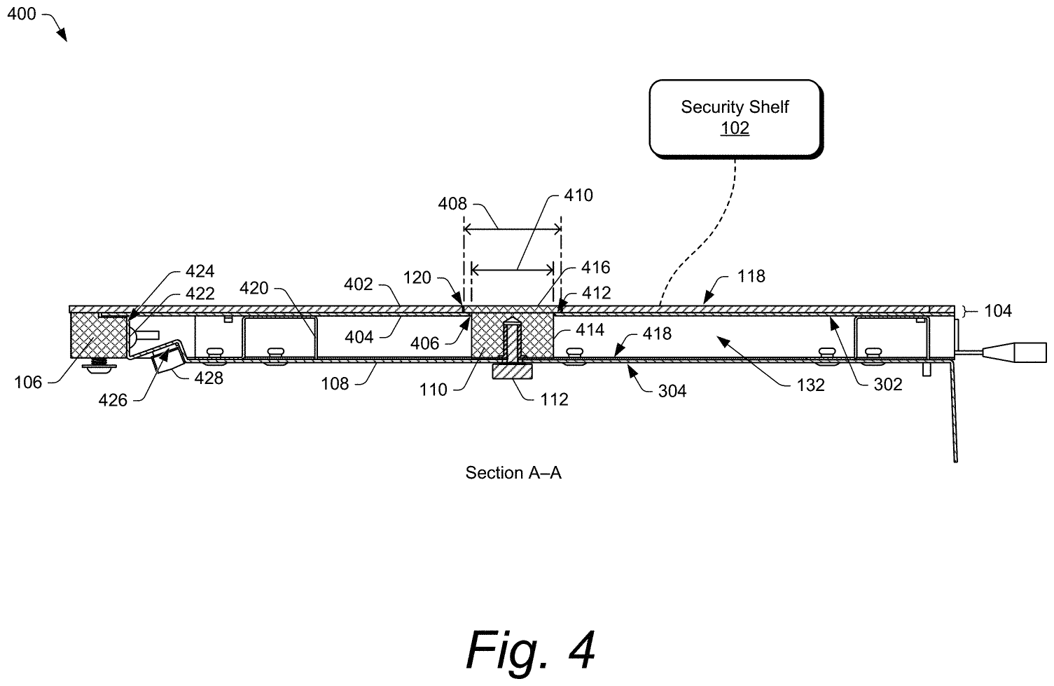

FIG. 4 illustrates a sectional view 400 of the high-security mounting system from FIG. 2, taken along line A-A. As illustrated, the shelf 104 has a top layer 402 and a sublayer 404. The top layer 402 has the mounting surface 118 and is stacked on top of the sublayer 404. The sublayer 404 is positioned on the opposing side of the shelf 104 from the mounting surface 118. The sublayer 404 defines holes (e.g., holes 406) that correspond to the holes 120, which are defined in the top layer 402. The hole 120 in the top layer 402 has a diameter 408 that is larger than a diameter 410 of the hole 406 in the sublayer 404. This difference in diameters provides a contact surface 412 for the plug 110. The plug 110 has a body 414 and a head 416, which are coaxial with one another. Notice the body 414 of the plug 110 is sized to fit within the smaller hole (e.g., the hole 406 in the sublayer 404), while the head 416 is sized to fit within the larger hole (e.g., the hole 120 in the shelf 104) but not the smaller hole. When the plug 110 is positioned within the holes 120 and 406, the plug 110 extends through the volume 132 to abut an interior surface 418 of the tray 108. The interior surface of the tray 108 is opposite the exterior surface 304 and faces the underside 302 of the shelf 104. When the plug is positioned within the holes 120 and 406 and connected to the threaded-stem fastener 112, the plug 110 and the threaded-stem fastener 112 together apply a compression force to the contact surface 412 of the sublayer 404 and the exterior surface 304 of the tray 108. This arrangement further enables the plug 110 to be substantially flush with the mounting surface 118.

As described, the tray 108 defines the volume 132 when connected to the shelf 104. For example, one or more frame portions 420 may extend between the tray 108 and the sublayer 404 of the shelf 104. The frame portions 420 are configured to abut the sublayer 404 and the tray 108. In an example, the frame portions 420 are connected (e.g., fastened) to the tray 108 or the sublayer 404. In some aspects, the frame portions 420 may be connected to both the tray 108 and the sublayer 404. The frame portions 420 may provide structural support to the shelf 104 and the tray 108 to counter the compression forces applied by the plugs 110 and threaded-stem fasteners 112 in the middle of the shelf 104. In aspects, the tray 108 includes a side wall 422 that attaches to an interior surface 424 of the trim 106. This attachment is to not only enable the trim 106 to provide a cosmetic exterior to the front of the shelf 104 but also to increase the difficulty of a thief disassembling the tray 108 from the shelf 104.

The tray 108 may also include a recessed area 426 to accommodate, for example, a lighting device 428 (e.g., light-emitting diode (LED) light strip), one or more sensors (e.g., motion sensors to activate a device), or any other suitable device positioned underneath the shelf 104 and proximate to the trim 106.

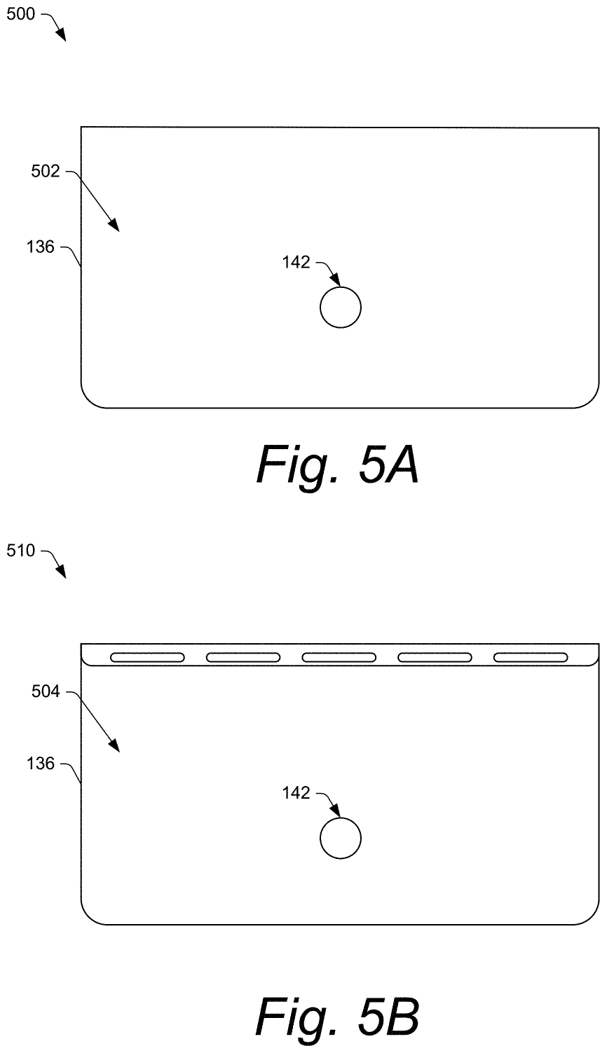

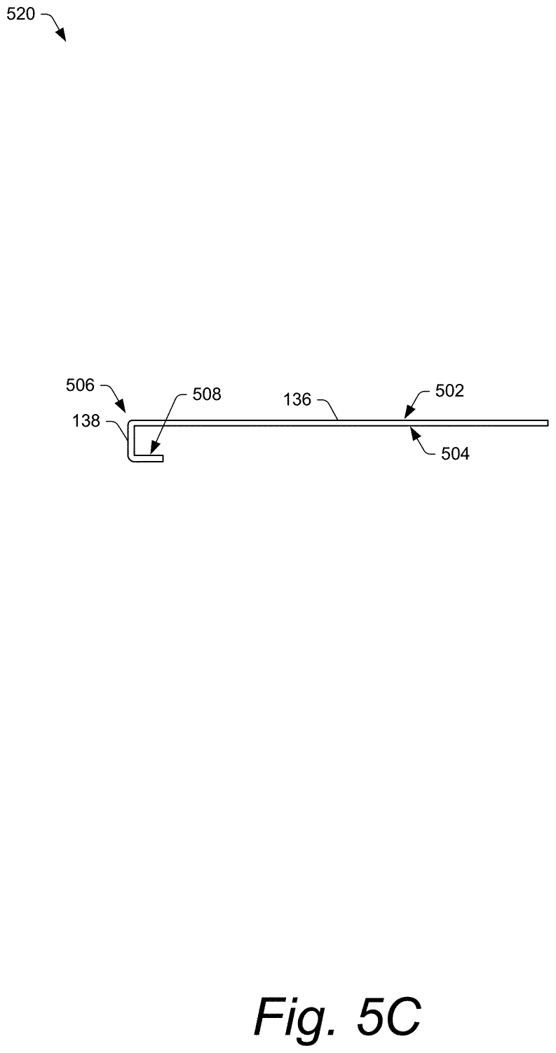

FIG. 5A illustrates a top plan view 500 of the placemat 136 from FIG. 1. FIG. 5B illustrates a bottom plan view 510 of the placemat 136 from FIG. 1. FIG. 5C illustrates a right elevational view 520 of the placemat 136 from FIG. 1. The placemat 136 may include any suitable number of holes 142 that correspond to the holes 120 in the shelf 104; for example, the illustrated example in FIGS. 5A through 5C include a single hole 142. However, the placemat 136 may include two or more holes 142. The placemat 136 has a top surface 502 and an opposing, bottom surface 504. The top and bottom surfaces 502 and 504, respectively, are substantially planar. The placemat 136 also includes an extending member 138 located at one end 506 of the placemat 136. The extending member 138 extends outward from the bottom surface 504 in a direction substantially orthogonal to the bottom surface 504 and then bends to return in a direction substantially parallel to the bottom surface 504 of the placemat 136. This return provides a surface 508 that captures a portion of the underside of the trim 106 on the front of the shelf 104.

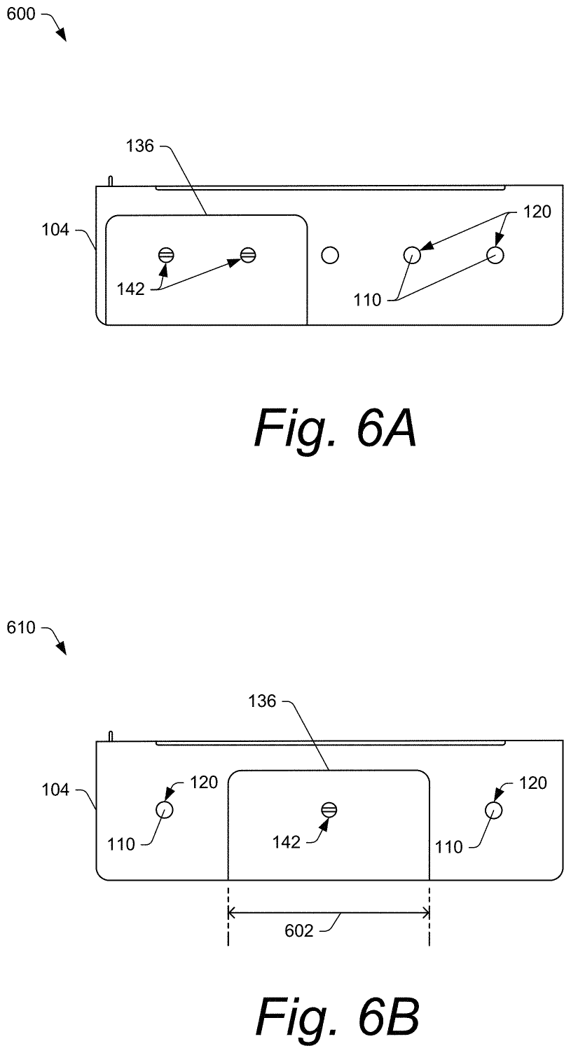

FIGS. 6A and 6B illustrate example implementations 600 and 610, respectively, of the placemat 136 assembled to the security shelf 102 from FIG. 1. In FIG. 6A, the placemat 136 includes two holes 142, each aligned with one of the holes 120 in the shelf 104. In aspects, the two holes 142 are aligned with two adjacent holes of the series of holes 120 in the shelf 104. In this “two-hole” configuration, two devices can be mounted to the shelf 104, each using one of the two holes 142 in the placemat 136. The other holes 120 in the shelf 104 are not covered by the placemat 136 and are filled with the plugs 110. The placemat 136, having the two-hole configuration, can be aligned with any two adjacent holes 120 in the shelf 104 and is not necessarily limited to the illustrated example.

In FIG. 6B, the placemat 136 includes a single hole 142. In this “one-hole” configuration, the placemat 136 may, due to its width (e.g., width 602), cover one or more other holes 120 in the shelf 104. Notice that only three of the five holes 120 in the shelf 104 are visible in this one-hole configuration. The placemat 136, having the one-hole configuration, may be aligned with any middle hole in the series of holes 120 in the shelf 104. Such a configuration may be useful to center the device being displayed on the shelf 104.

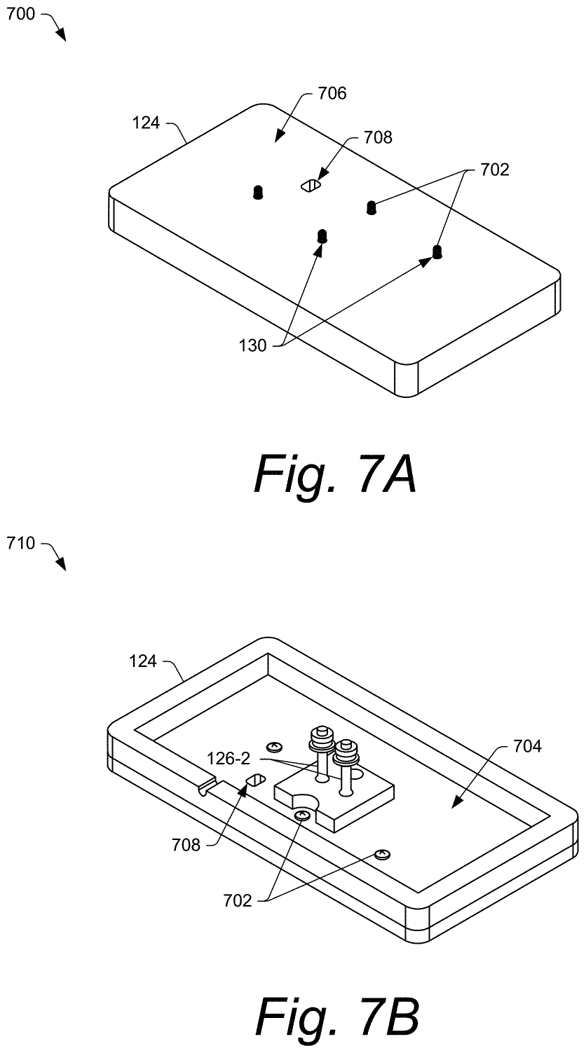

FIG. 7A illustrates a top-right isometric view 700 of the riser 124 from FIG. 1. FIG. 7B illustrates a bottom-right isometric view 710 of the riser 124 from FIG. 1. The riser 124 may be designed to uniquely correspond to a particular device (e.g., the electronic device 128-2) to be mounted to the shelf 104 (shown in FIG. 1). As such, the riser 124 may include a configuration of through-holes (e.g., the holes 130) arranged to accommodate a mounting-hole pattern of the device to be mounted. Threaded fasteners 702 may be inserted through the holes 130 from an inner surface 704 of the riser 124 toward an outer surface 706 of the riser 124 and threaded into threaded inserts (not shown) on the electronic device being mounted. The riser 124 may also define a through hole 708 that is sized sufficiently to enable a power cord to extend through the through hole 708.

As described herein, the riser 124 also includes threaded stems 126-2, which are configured to extend through aligned holes in the shelf 104, the tray 108, and optionally the plate 114, to mate with one of the threaded-insert fasteners 116 on the bottom side of the tray 108 (or the bottom side of the plate 114), as illustrated in FIG. 1. Alternatively, the threaded stems 126-2 may be separate from the riser 124 and may be connected to the riser 124 via threaded inserts in the riser 124. In this way, the threaded inserts in the riser 124 may be configured to receive a threaded-stem fastener (e.g., the threaded stem 126-2) extending through the holes in the shelf 104, the tray 108, and optionally the plate 114, to retain the riser 124 to the mounting surface 118. Accordingly, after fastening the electronic device 128-2 to the outer surface 706 of the riser 124, the riser 124 can be fastened to the shelf 104, as shown in FIG. 1.

As described, the holes 130 in the riser 124 define a hole pattern corresponding to a configuration of mounting hardware of the electronic device 128. Further, the threaded stems 126-2 are positioned relative to one another in a pattern that is spatially different than the hole pattern of the holes 130. For example, the threaded stems 126-2 may be positioned proximate to one another (e.g., less than five centimeters apart), whereas the holes 130 may be spaced apart by a larger distance (e.g., greater than five centimeters apart). The riser 125 thus adapts the configuration of mounting hardware of the electronic device 128 to the fixed holes (e.g., holes 120) in the mounting system.

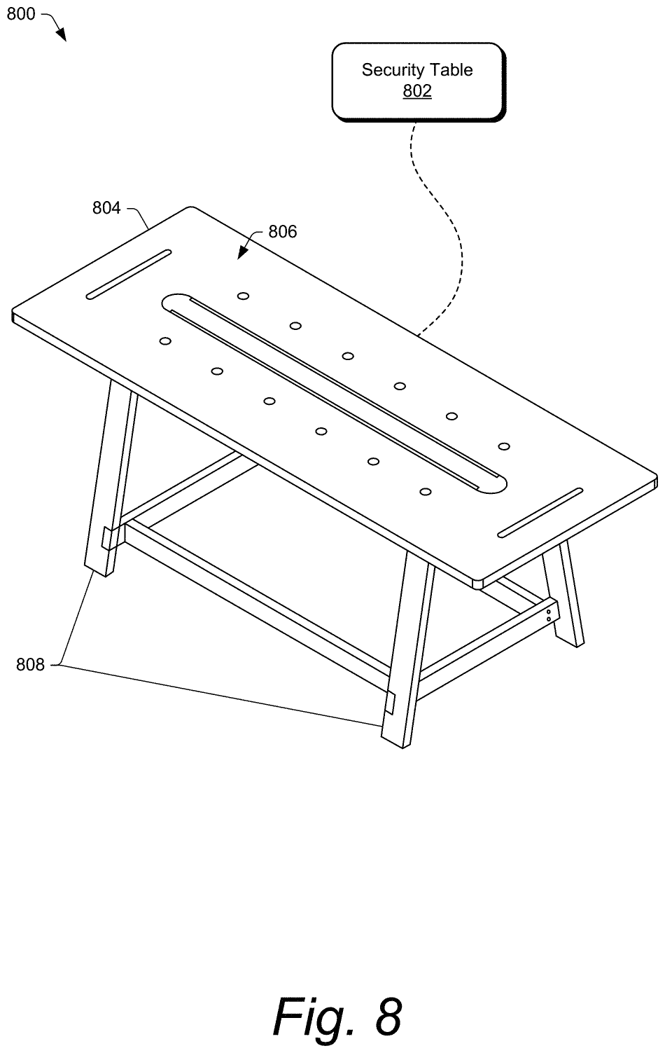

FIG. 8 illustrates a front-right isometric view 800 of an example high-security mounting system (e.g., security table 802) for retail device display. The security table 802 provides a high degree of security and resistance against theft of electronic devices mounted onto the security table 802 for retail display. In the illustrated example, the security table 802 includes a tabletop 804 having a mounting surface 806, similar to the mounting surface 118 of the security shelf 102 in FIG. 1. Unlike the security shelf 102, which is configured to be mounted to a wall, the security table 802 includes multiple legs 808 that enable the security table 802 to be free standing.

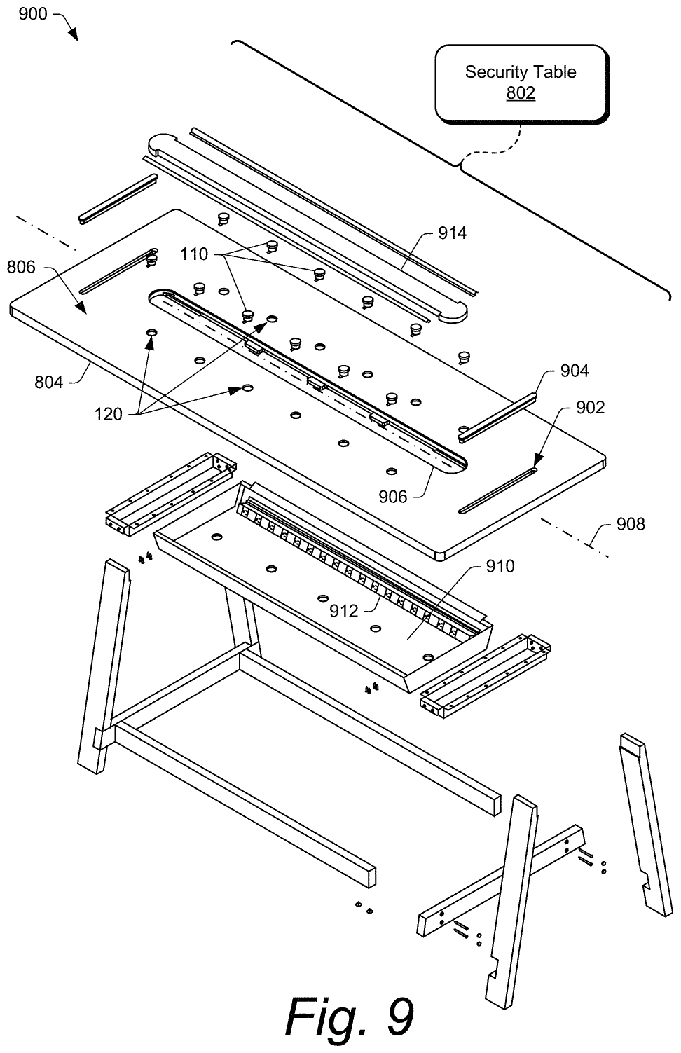

Consider FIG. 9, which illustrates an exploded view 900 of the example security table 802 from FIG. 8. Similar to the security shelf 102 described in relation to FIGS. 1-7, the security table 802 may define a series of holes (e.g., the holes 120) and plugs (e.g., the plugs 110) configured to be positioned in the holes 120. The holes 120 are defined to enable hardware from a stand (e.g., the device stand 122, the riser 124) to extend through the holes to engage with additional hardware underneath the mounting surface to enable the stand (and a device attached to the stand) to be attached to the mounting surface 806 of the security table 802. Accordingly, the device stand 122 and the riser 124, described with reference to FIGS. 5A through 7B may be assembled to the security table 802 in a similar manner to how the device stand 122 and the riser 124 can be used with the security shelf 102 described with reference to FIG. 1. The riser 124 may be configured as a mechanical-hardware adapter between the tabletop 804 and the electronic device 128 or the device stand 122. Also, the security table 802 may be configured to enable assembly of a placemat (e.g., the placemat 136 from FIG. 1) to the tabletop 804, such that the placemat 136 wraps around a front edge of the tabletop 804, similar to assembling the placemat 136 to the security shelf 102 in FIG. 1.

The security table 802 may also include one or more elongated holes 902 and elongated plugs 904 configured to be removably inserted into the elongated holes 902. The elongated holes 902 may provide flexibility in positioning a mounted device and/or a placemat in one dimension (e.g., a direction parallel to the edge of the mounting surface 806). Further, the elongated holes 902 may be located at any suitable location in the tabletop 804. In the illustrated example, the elongated holes 902 are located proximate to opposing ends of the tabletop 804.

In aspects, the series of holes 120 may be defined in two rows that run lengthwise along the tabletop 804 of the security table 802. Any suitable number of rows can be used for hole placement. In aspects, the holes 120 are positioned at a fixed distance from the edge of the tabletop 804 to enable the placemat 136 (shown in FIGS. 5A through 5C) to be assembled and have its holes (e.g., holes 142) aligned with one or more of the holes 120 in the tabletop 804. The security table 802 may further define a channel 906 that runs lengthwise along a center axis 908 of the tabletop 804. The elongated holes 902 may be substantially orthogonal to the center axis 908. Power cords of mounted devices may be extended through the channel 906 and down into an electrical tray 910. The electrical tray 910 may support a power strip 912 to provide power to a plurality of electronic devices mounted to the mounting surface 806. A cap 914 may be configured to be positioned within the channel 906.

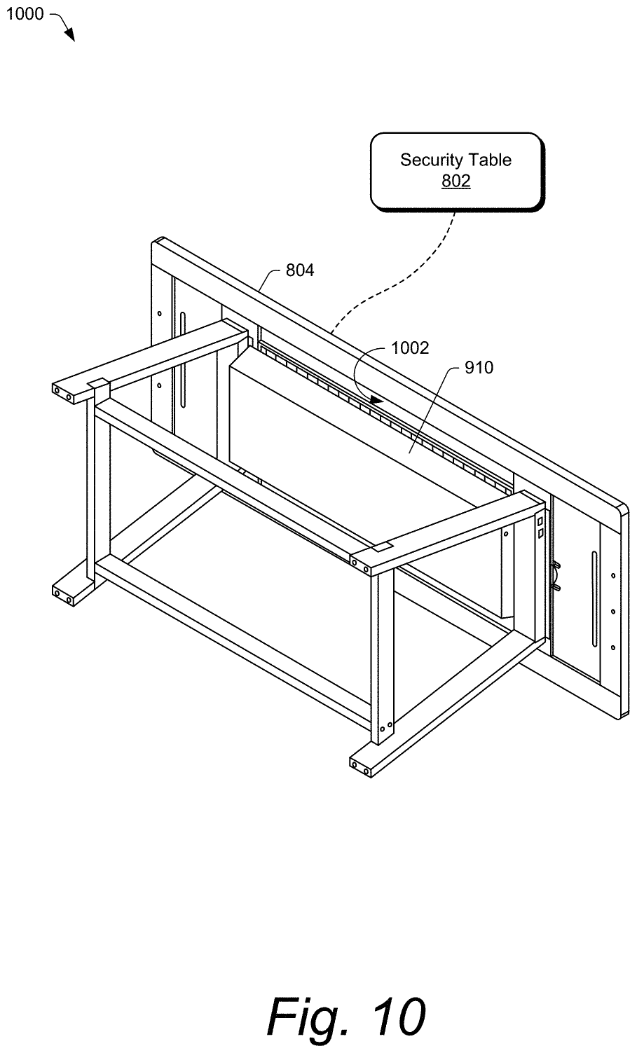

FIG. 10 illustrates a bottom-right isometric view 1000 of the example security table from FIG. 8. When assembled, the electrical tray 910 is attached to a bottom surface 1002 of the tabletop 804, which may include a sublayer similar to the sublayer 404 of the security shelf 102.

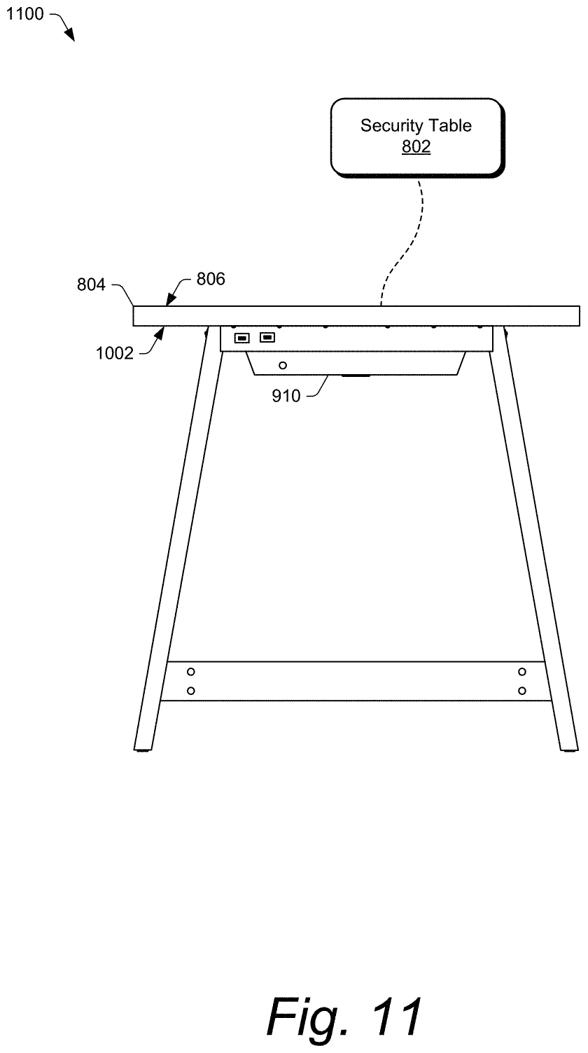

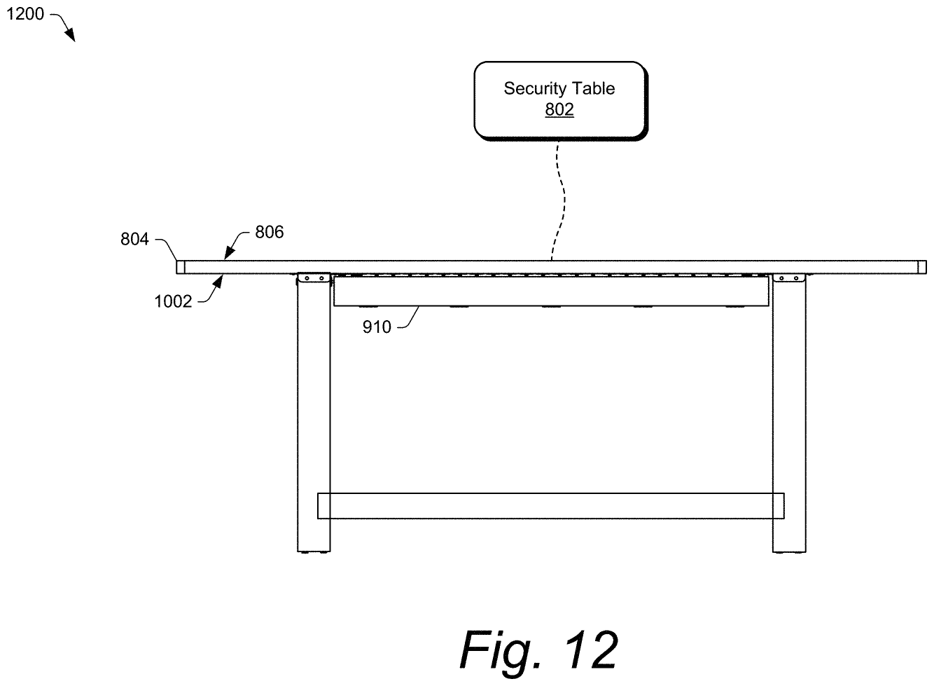

FIG. 11 illustrates a right elevational view 1100 of the example security table 802 from FIG. 8. FIG. 12 illustrates a front elevational view 1200 of the example security table 802 from FIG. 8. The mounting surface 806 of the tabletop 804 is illustrated as being substantially planar. The electrical tray 910 is illustrated as being attached to the bottom surface 1002 of the tabletop 804. The security table 802 can have any suitable size, and the features described herein are scalable to larger or smaller dimensions. One example includes the tabletop 804 having a length of approximately 7.5 feet and a width of approximately 3 feet.

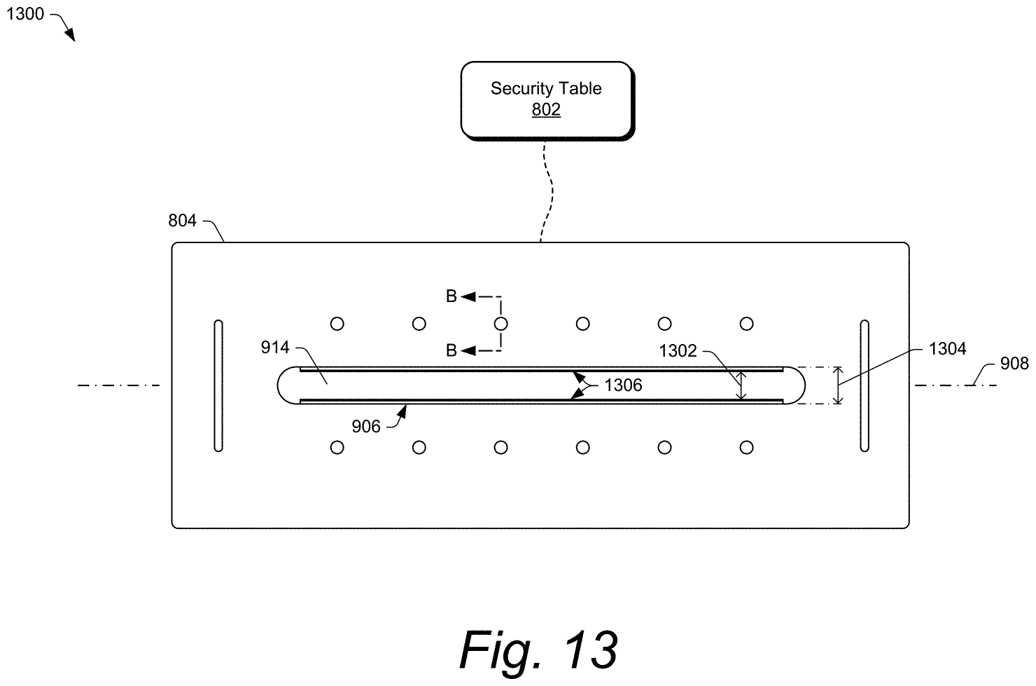

FIG. 13 illustrates a top plan view 1300 of the example security table 802 from FIG. 8. In the top plan view 1300, the cap 914 is positioned within the channel 906 of the tabletop 804. The cap 914 includes a width 1302 that is smaller than a width 1304 of the channel 906 to form two smaller channels 1306 on opposing sides of the center axis 908 and between the cap 914 and the tabletop 804 for receiving the power cords of electronic devices fastened to the tabletop 804. The cap 914 is thus configured to (i) reduce the opening of the channel 906 to a size suitable for the power cords of the mounted devices and (ii) prevent access to the electrical tray 910 (shown in FIG. 9) by a human hand through the channel 906. Accordingly, the cap 914 prevents a thief from retrieving a power cord that extends through the channel 906.

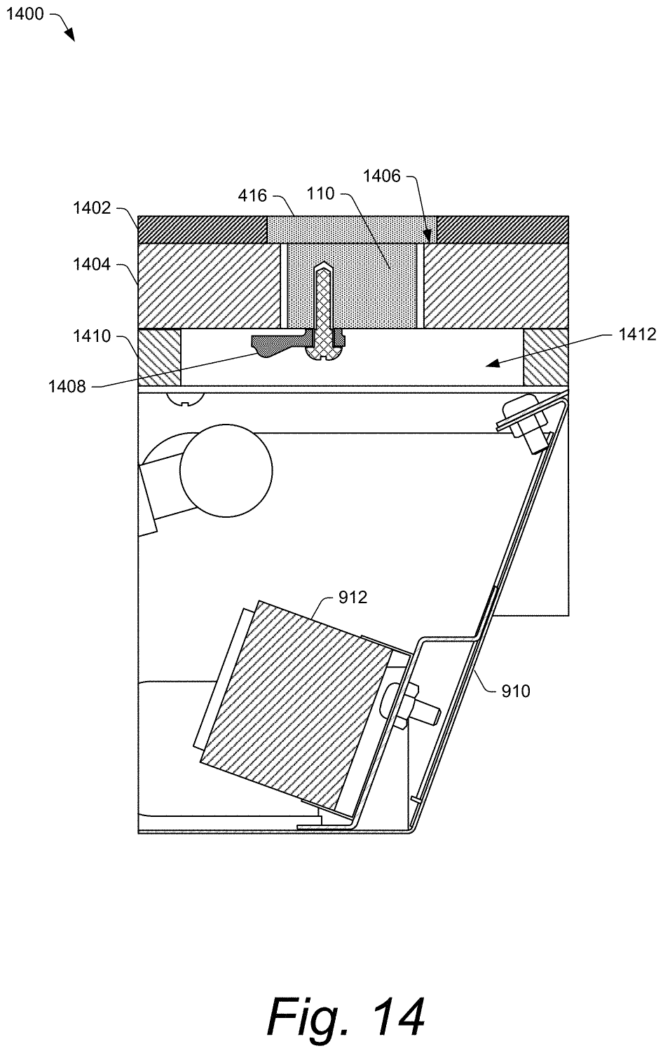

FIG. 14 illustrates a sectional view 1400 of the example security table from FIG. 13, taken along line B-B. In the sectional view 1400, the tabletop 804 is illustrated as having a top layer 1402 and a sublayer 1404. The top layer 1402 defines the mounting surface 806. The sublayer 1404 may be similar to the sublayer 404 of the security shelf 102 in FIG. 4. In aspects, the plug 110 may extend through the hole 120 in the tabletop 804, which includes a first diameter in the top layer 1402 and a second, smaller diameter in the sublayer 1404. This difference in diameters of the hole 120 in the top layer 1402 and the sublayer 1404 provides a contact surface 1406 to abut the cap 914 of the plug 110. Alternatively, the top layer 1402 and the sublayer 1404 may be a single layer, and the hole 120 may be counterbored to provide the contact surface 1406.

A fastening mechanism 1408 can be used to retain the plug 110 in the hole 120. In an example, the fastening mechanism includes a latch mechanism that rotates to capture a portion of the bottom surface 1002 of the tabletop 804 (e.g., a portion of the sublayer 404) that is proximate to the hole 120. In this way, the fastening mechanism prevents removal of the plug 110 from the hole 120. In some aspects, the security table 802 also includes a secondary sublayer 1410, which may be any suitable material (e.g., medium-density fibreboard (MDF) board) to provide structural support to the tabletop 804. The secondary sublayer 1410 may define oversized holes (e.g., oversized hole 1412) aligned with the holes 120 in the tabletop 804 and oversized in comparison to the holes 120. The oversized holes 1412 enable the security table 802 to use the same-sized plugs 110 as the security shelf 102, which results in the plugs 110 being reusable between systems. In addition, the secondary sublayer 1410 or the sublayer 1404 can support the cap 914 within the channel 906. For example, the secondary sublayer 1410 or the sublayer 1404 can include one or more portions that overlap with the channel 906 to create a contact surface on which the cap 914 may rest when positioned within the channel 906.

Because of the size of the security table 802 and the number of electronic devices that can be mounted to the security table 802, the electrical tray 910 is sized to accommodate several power cords and adapters. As described herein, a power strip (e.g., the power strip 912) may be located in the electrical tray 910, resulting in only a single power cord (e.g., the power cord of the power strip 912) exiting the electrical tray 910 and extending to a power source.

### CONCLUSION

Although aspects of the high-security mounting system for retail device display have been described in language specific to features and/or methods, the subject of the appended claims is not necessarily limited to the specific features or methods described. Rather, the specific features and methods are disclosed as example implementations of the claimed high-security mounting system for retail device display, and other equivalent features and methods are intended to be within the scope of the appended claims. Further, various different aspects are described, and it is to be appreciated that each described aspect can be implemented independently or in connection with one or more other described aspects.

What is claimed is:

1. A high-security mounting system for retail device display, the mounting system comprising:
a shelf having a mounting surface on which to mechanically fasten one or more electronic devices for retail display, the shelf defining a series of holes distributed along a lengthwise direction of the shelf and configured to receive threaded-stem fasteners corresponding to a device stand of the one or more electronic devices;
a tray attached to the shelf and positioned proximate to a bottom side of the shelf from the mounting surface to define a volume between the tray and the shelf that is usable to house electrical cords of the one or more electronic devices fastened to the mounting surface, the tray defining a series of slots aligned with the series of holes in the shelf and configured to receive the threaded-stem fasteners of the device stand, the threaded-stem fasteners configured to mate with threaded-insert fasteners to secure the device stand to the shelf and the tray and provide a first degree of resistance against a pull force applied to the device stand; and
one or more plugs configured to be inserted into one or more holes of the series of holes in the shelf that are not used for fastening the one or more electronic devices to the shelf, each of the one or more plugs configured to:
extend through the volume to abut an interior surface of the tray that faces the bottom side of the shelf; and
connect to a threaded-stem fastener configured to capture an exterior surface of the tray that is opposite the interior surface to help retain the tray to the shelf.

2. The mounting system of claim 1, further comprising a placemat, wherein the placemat:
includes a rigid material;
is positioned on the mounting surface and attached to the device stand; and
has an extending member that wraps around an edge of the shelf and captures a portion of an underside of the shelf to provide a second degree of resistance against the pull force applied to the device stand.

3. The mounting system of claim 2, wherein the placemat is attached to the device stand via adhesive.

4. The mounting system of claim 2, wherein the placemat defines a hole configured to be aligned with one hole of the series of holes in the shelf, the placemat having a width that covers one or more additional holes of the series of holes in the shelf.

5. The mounting system of claim 2, wherein the placemat defines two holes configured to be aligned with two adjacent holes of the series of holes in the shelf.

6. The mounting system of claim 1, further comprising a riser configured as a mechanical-hardware adapter between the shelf and an electronic device of the one or more electronic devices.

7. The mounting system of claim 6, wherein:
the riser includes a top surface defining a hole pattern and a bottom surface having threaded stems positioned relative to one another in a pattern that is spatially different than the hole pattern on the top surface;
the hole pattern corresponds to a configuration of mounting hardware for the electronic device to be fastened to the riser; and
the threaded stems are configured to:
extend through a hole of the series of holes in the shelf and through a corresponding slot of the series of slots in the tray; and
connect to a threaded-insert fastener proximate to the exterior surface of the tray to capture the exterior surface of the tray and retain the riser to the mounting surface.

8. The mounting system of claim 6, further comprising a riser, wherein:
the riser includes a top surface defining a hole pattern and a bottom surface having threaded inserts positioned relative to one another in a pattern that is spatially different than the hole pattern on the top surface;
the hole pattern corresponds to a configuration of mounting hardware for the electronic device to be fastened to the riser; and
the threaded inserts are configured to:
receive a threaded-stem fastener extending through a hole of the series of holes in the shelf and through a corresponding slot of the series of slots in the tray; and
connect to the threaded-stem fastener to retain the riser to the mounting surface.

9. The mounting system of claim 2, wherein the tray and the placemat each include a metal material.

10. A high-security mounting system for retail device display, the mounting system comprising:
a tabletop having a mounting surface on which to mechanically fasten one or more electronic devices for retail display, the tabletop defining a series of holes distributed along a lengthwise direction of the tabletop and configured to receive threaded-stem fasteners corresponding to a device stand of the one or more electronic devices to fasten the one or more electronic devices to the tabletop, the tabletop defining a channel that runs in a lengthwise direction along a center axis of the tabletop, the channel configured to receive electrical cords of the one or more electronic devices fastened to the tabletop;
an electrical tray attached to the tabletop and positioned proximate to a bottom side of the tabletop to define a volume between the electrical tray and the tabletop that is usable to house the electrical cords of the one or more electronic devices fastened to the mounting surface; and
one or more plugs configured to be removably inserted into one or more holes of the series of holes in the tabletop that are not used for mounting the one or more electronic devices, each of the one or more plugs having a latch mechanism configured to retain the plug in a respective hole by capturing a bottom surface of the tabletop.

11. The mounting system of claim 10, wherein the tabletop defines:
the series of holes in an arrangement comprising two rows that are substantially parallel to one another; and
the channel between the two rows of the series of holes.

12. The mounting system of claim 10, wherein:
the tabletop includes a contact surface that is within the respective hole and substantially parallel to the mounting surface; and
the plug is configured to abut the contact surface within the respective hole.

13. The mounting system of claim 10, further comprising a cap configured to be positioned within the channel, wherein:
when the cap is positioned within the channel, two smaller channels are formed on opposing sides of the center axis and between the cap and the tabletop for receiving the electrical cords of the one or more electronic devices and preventing access to the electrical tray by a human hand through the channel.

14. The mounting system of claim 13, wherein the cap is supported within the channel by a sublayer of the tabletop.

15. The mounting system of claim 10, wherein the electrical tray supports a power strip to provide power to the one or more electronic devices fastened to the tabletop.

16. The mounting system of claim 10, wherein:
the one or more holes include at least one elongated hole that is substantially orthogonal to the center axis; and
the one or more plugs include at least one elongated plug corresponding to the at least one elongated hole.

17. The mounting system of claim 10, further comprising a placemat, wherein the placemat:
includes a rigid material;
is positioned on the mounting surface and attached to the device stand; and
has an extending member that wraps around an edge of the tabletop and captures a portion of an underside of the tabletop to resist a pull force applied to the device stand.

18. The mounting system of claim 10, further comprising a riser configured as a mechanical-hardware adapter between the one or more holes in the tabletop and mounting hardware of an electronic device of the one or more electronic devices.

19. The mounting system of claim 18, wherein:
the riser includes a top surface defining a hole pattern and a bottom surface having threaded stems positioned relative to one another in a pattern that is spatially different than the hole pattern on the top surface;
the hole pattern corresponds to a configuration of mounting hardware for the electronic device to be fastened to the riser; and
the threaded stems are configured to:
extend through a hole of the series of holes in the tabletop and through a plate positioned proximate to the bottom side of the tabletop; and
connect to a threaded-insert fastener on an opposing side of the plate to capture the plate against the bottom side of the tabletop and retain the riser to the mounting surface.

20. The mounting system of claim 18, wherein:
the riser includes a top surface defining a hole pattern and a bottom surface having threaded inserts positioned relative to one another in a pattern that is spatially different than the hole pattern on the top surface;
the hole pattern corresponds to a configuration of mounting hardware for the electronic device to be fastened to the riser; and
the threaded inserts are each configured to:
receive a threaded-stem fastener extending through a hole of the series of holes in the tabletop and through a corresponding plate positioned proximate to the bottom side of the tabletop; and
connect to the threaded-stem fastener to retain the riser to the mounting surface.
